(19) United States
(12) Patent Application Publication
(10) Pub. No.: US 2016/0347113 A1
(43) Pub. Date: Dec. 1, 2016

(54) STATIONERY BOX WITH ROTARY CALENDAR

(71) Applicant: HAECHEOL KIM, Busan (KR)

(72) Inventor: HAECHEOL KIM, Busan (KR)

(21) Appl. No.: 14/722,988

(22) Filed: May 27, 2015

(51) Int. Cl. B43M 99/00; G09D 3/06; B42D 5/00

(52) U.S. Cl. CPC B43M 99/001; B42D 5/006; G09D 3/06

(57) ABSTRACT

A stationery box with a rotary calendar consists of: an rectangular-shaped adhesive note box on one side to accommodate adhesive notes; an adhesive note box cover to cover the aforesaid adhesive note box; an ink pad box adjacent to the aforesaid adhesive note box to accommodate ink pad; an ink pad box cover to cover the aforesaid ink pad box; a business card holder to organize a variety of business cards; a pencil vase to hold writing articles; a rotary calendar provided on the front; and a turning button attached on one side to change the date of the rotary calendar. The stationery box with a rotary calendar enables a neat organization of stationery items carelessly scattered on the desk to increase the efficiency in the business processes.

### BACKGROUND OF THE INVENTION

Field of the Invention

The present invention relates to a stationery box with a rotary calendar which allows a neat organization of stationery.

Description of Related Art

Stationery is indispensable to modern people including students, office workers, and housewives, and becomes a necessity for life. Particularly, stationery that allows to raise the efficiency in business is critical for those working in the office, and this is the reason why so many idea products pour out. Among them are various stationery items and desk calendar that take big part on the desk.

However, stationery items are often kept untidy on the desk, and desk calendars take a lot of space.

But, the conventional technology uses the existing desk calendars as they are, with the space taken by those calendars unchanged, giving an inconvenience since stationery box is located inside the desk calendar.

### SUMMARY OF THE INVENTION

It is, therefore, an object of the present invention to solve the aforementioned problems by providing stationery box equipped with a rotary calendar (60) of which the date is changed by the turn of button.

This invention is characterized in that the stationery box with a rotary calendar consists of rectangular-shaped adhesive note box on one side to accommodate adhesive notes; an adhesive note box cover to cover the aforesaid rectangular-shaped adhesive note box; an ink pad box adjacent to the aforesaid rectangular-shaped adhesive note box to accommodate the ink pad; an ink pad box cover to cover the aforesaid ink pad box; a business card holder to organize a variety of business cards; a pencil vase to hold writing articles; a rotary calendar provided on the front, and turning button attached on one side to change the date of the rotary calendar.

The effect of this invention is as follows:

The invention enables a neat organization of stationery items carelessly scattered on the desk to increase the efficiency in the business processes.

In addition, there is no need to have a separate desk calendar on the desk due to the calendar built in the box, and accordingly it is possible to reduce the area taken by the desk calendar and organize the desk neatly.

Because built-in rotary calendar is not a one-off but can be used year after year, people can also save a calendar cost.

In addition, since the various boxes in the stationery box are prefabricated and assembled for an easy move, they can be placed and used to the needs of users.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a perspective view illustrating a conventional stationery storage unit.

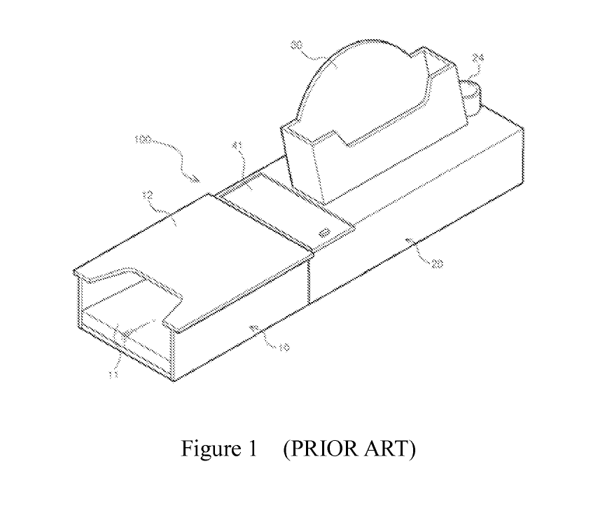

FIG. 2 is a perspective view illustrating the stationery box with a rotary calendar of this invention.

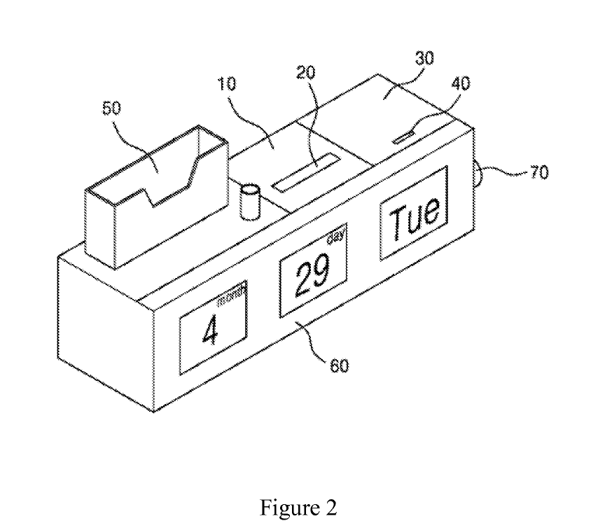

### DETAILED DESCRIPTION OF THE PREFERRED EMBODIMENTS

Hereinafter, stationery box with a rotary calendar will be described with reference to the accompanying drawings.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

The stationery box of this invention consists of a rectangular-shaped adhesive note box (10) on one side to accommodate adhesive notes, an adhesive note box cover (20) to cover the aforesaid adhesive note box, an ink pad box (30) adjacent to the aforesaid adhesive note box to accommodate ink pad, an ink pad box cover (40) to cover the aforesaid ink pad box, an business card holder (50) to organize a variety of business cards, a pencil vase to hold writing articles, a rotary calendar (60) provided on the front, and a turning button (70) attached on one side to change the date of the rotary calendar.

Hereinafter, each configuration will be described in detail.

First, the present invention is made into a rectangular shape as a whole.

The above adhesive note box is generally formed in a rectangular shape on one side to accommodate post-it, with its top open to be covered by an adhesive note box cover (20).

The adhesive note box cover (20) is a subsidiary material to cover the above note box.

Therefore, the adhesive note box cover (20) is to close the aforesaid note box.

Aforesaid ink pad box (30) is a space for accommodating various seals of companies.

The cover of the aforesaid ink pad box (30) is a tool to cover the ink pad, in like manner of the adhesive note box cover (20) above.

The aforesaid rotary calendar (60) is formed in a rectangular shape on the front, and the turning button (70) is used to turn the rotary calendar (60).

The aforesaid rotary calendar is characterized to be removable from the body of stationery box.

As described above, the basic idea of this invention is to form a rotary calendar in the storage space. This is only for illustration, and as those of ordinary skill in the art will recognize that various modifications and equivalent embodiments are possible therefrom, true technical protection scope of the present invention is definitely defined only in the appended claims.

What is claimed is:

1. A stationery box with a rotary calendar, which is made up of:
a rectangular-shaped adhesive note box (10) on one side to accommodate adhesive notes; an adhesive note box cover (20) to cover the rectangular-shaped adhesive note box (10); an ink pad box (30) adjacent to the rectangular-shaped adhesive note box to accommodate ink pad; an ink pad box cover (40) to cover the ink pad box (30); a business card holder (50) to organize a variety of business cards; a pencil vase to hold writing articles; a rotary calendar (60) provided on the front; and a turning button (70) attached on one side to change the date of the rotary calendar (60).

2. The stationery box with a rotary calendar of claim 1, wherein a removable rotary calendar is installed.
